(19) United States
(12) Patent Application Publication
(10) Pub. No.: US 2004/0130634 A1
(43) Pub. Date: Jul. 8, 2004

(54) Electronic image history attribute

(76) Inventors: Beth M.P. Delaney, Loveland, CO (US); John P. Dutton, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/337,636

(22) Filed: Jan. 6, 2003

(51) Int. Cl. H04N 5/262

(52) U.S. Cl. 348/231.99

(57) ABSTRACT

A history attribute is associated with an electronic image, containing a history of actions performed with the electronic image, such as where copies of the image are transmitted, whether the image has been printed, etc.

### BACKGROUND

As personal computers have become increasingly powerful, the World Wide Web (WWW or web) has gained popularity, electronic imaging devices have become capable and affordable, and electronic images have gained enormous importance. Electronic images may be easily captured by electronic imaging devices or otherwise generated on computers and used in many ways, such as printing them, transmitting by electronic mail or other means, posting to web sites, copying and storing on any number of media, etc. Electronic images may be edited on devices such as computers and electronic imaging devices, and it is known to provide an undo list indicating what changes have been made to an image.

Electronic imaging devices such as digital cameras are used in a wide range of applications and are steadily becoming less expensive and simpler to use. Electronic imaging devices generate images that can be viewed and shared immediately. Image quality is now limited more by output devices than by the electronic imaging devices, and electronic images may be stored indefinitely without the image degradation suffered by film-based images. Electronic imaging devices can also rapidly capture large numbers of images which can be previewed and stored or deleted as desired. As the capacity of removable solid-state memories has increased and price has gone down, typical electronic imaging devices can now capture and internally store hundreds of electronic images. Electronic imaging devices can perform a variety of tasks with images, such as printing, posting to a web page on the World Wide Web, transmitting to others by electronic mail (email) or other means, etc.

As the profusion of electronic images grows and more tasks are devised that can be performed with electronic images, it becomes increasingly difficult to keep track of what has been done with images. For example, one might intend to transmit a number of images electronically to different recipients, to copy certain images from an electronic imaging device to a computer, and to store others in various locations on media servers. The wide variety of potential tasks that may be performed with electronic images, and the increasing number of electronic devices that use electronic images, can greatly complicate management of electronic images. It may be difficult to remember if, for example, a particular image has been transmitted to all intended recipients, or in what locations the image has been stored.

### SUMMARY

A history attribute may be associated with an electronic image indicating what has been done with the image. The history attribute may be added, updated and accessed by any device using the electronic image, such as an electronic imaging device that captures the image, or a computer that uses the image in any way including generating, storing, displaying, printing or transmitting the image, etc. The history attribute may be stored in the image file or in a separate file associated with the image file. The history attribute may be accessed and displayed in user readable form, such as by displaying a list of the actions taken with the electronic image on a computer monitor or a display panel in an electronic imaging device.

### BRIEF DESCRIPTION OF THE DRAWING

Illustrative embodiments of the invention are shown in the accompanying drawing, in which:

FIG. 1 is an isometric front view illustration of an exemplary embodiment of an electronic imaging device which may employ intent attributes;

FIG. 2 is an isometric rear view illustration of the exemplary embodiment of the electronic imaging device of FIG. 1;

FIG. 3 is a block diagram of an exemplary embodiment of an electronic imaging device connected to a computer;

FIG. 4 is an illustration of an exemplary embodiment of an electronic imaging device connected to a computer by a cable;

FIG. 5 is an illustration of an exemplary embodiment of an electronic imaging device connected to the Internet by a wireless connection;

FIG. 6 is an illustration of an exemplary embodiment of an electronic imaging device connected to a printer by a wireless connection;

FIG. 7 is a block diagram of an exemplary association between an electronic image and a history attribute;

FIG. 8 is a block diagram of another exemplary association between an electronic image and a history attribute;

FIG. 9 is a block diagram of another exemplary association between electronic images and history attributes;

FIG. 10 is an illustration of an exemplary configuration of a history attribute;

FIG. 11 is an illustration of another exemplary configuration of a history attribute;

FIG. 12 is an illustration of another exemplary configuration of a history attribute;

FIG. 13 is an illustration of another exemplary configuration of a history attribute;

FIG. 14 is a flowchart summarizing an exemplary use of history attributes in an electronic device; and

FIG. 15 is a flowchart summarizing another exemplary use of history attributes in an electronic device.

### DESCRIPTION

The drawing and description, in general, disclose a history attribute that may be associated with an electronic image to record actions performed with the electronic image. For example, the history attribute may indicate that the electronic image has been transmitted by electronic mail, to whom, and when, or that the electronic image has been copied to a storage location on a personal computer, or that the electronic image has been printed. The history attribute may be associated with an electronic image in a variety of manners, such as embedding it in the file containing the electronic image, or storing it separately with a link between the history attribute and the electronic image. The history attribute may contain a single action or multiple actions, as desired, and may be accessed and displayed by any device processing, transmitting, storing, or otherwise accessing the electronic image, provided the device knows how to read the history attribute.

The history attribute may be generated, stored and accessed in any suitable device having access to the associated electronic image, such as an electronic imaging device or computer, etc. The electronic image may be generated in any suitable fashion, such as capturing it in an electronic imaging device or generating it on a computer using image processing software. An electronic imaging device refers herein to any device for capturing an electronic image, such as a dedicated imaging device like a digital camera, scanner, or video recorder, or a multi-purpose device such as a personal digital assistant (PDA) or cellular telephone, etc., having an imaging component.

The history attribute associated with an electronic image aids the user in tracking what has been done with an image. In contrast to undo lists in image editing software, which track changes to an image, the history attribute tracks tasks performed with an image, such as copying, moving, emailing, posting to the web, etc. This allows users to find out what has been done with the image, where it has been copied, to whom it has been transmitted, whether it has been printed, etc. For example, a user may access the history attribute to find out whether a specific electronic image has been posted to a web page without having to access the Internet.

Any type of device with access to an electronic image may be adapted to generate, store, or display history attributes. Although electronic image history attributes will be described herein with respect to an electronic image captured by an electronic imaging device, it is important to note that they are not limited to use with any particular type of device, and they may be generated or captured in any suitable manner. For example, the electronic imaging device may comprise a digital camera, video camera, scanner, etc. Before describing electronic image history attributes in detail, an exemplary digital camera which may capture electronic images and associate history attributes with the images will be described.

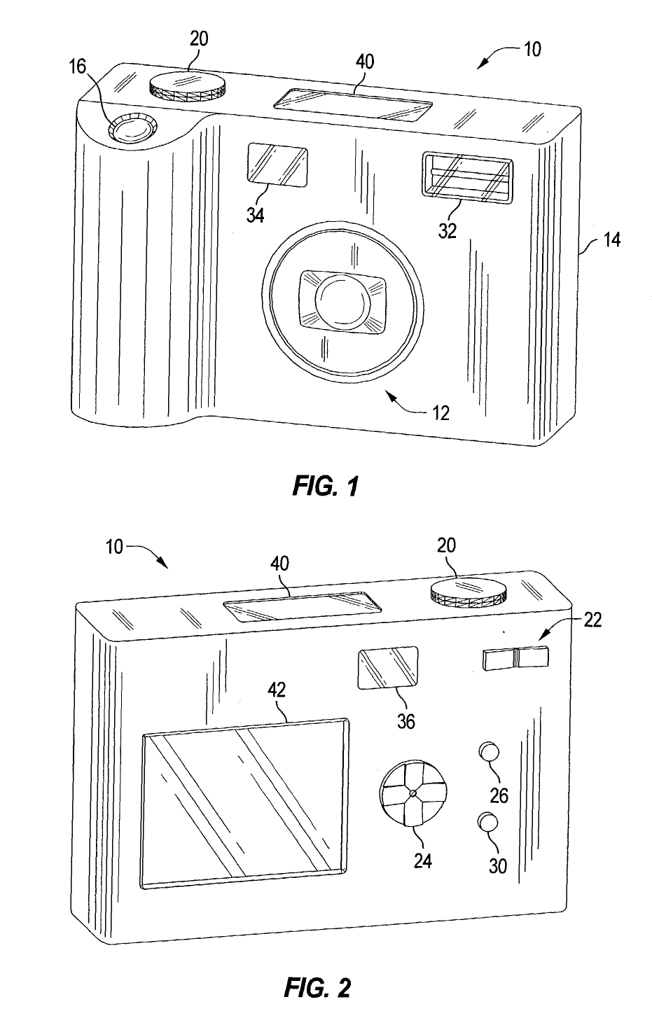

Referring now to FIGS. 1 through 3, an exemplary digital camera 10 comprises a housing portion or body 14 which is sized to receive the various systems and components required by the digital camera 10. For example, in the embodiment shown and described herein, the body 14 is sized to receive a lens assembly 12, a photodetector 60, an image processing system 66 to process and format the image data captured by the photodetector 60, and a solid-state storage device 72 to store the image data. The lens assembly 12 is located in the body 14 to allow light to enter the digital camera 10 and to focus it on the photodetector 60.

The digital camera 10 may include a processor 62 for controlling the operation of the digital camera 10 and for performing any needed tasks. The processor 62 may comprise one or more general purpose processors, and may be dedicated to a single task in the digital camera 10 or may be shared for multiple tasks. Alternatively, the processor 62 may comprise one or more application specific integrated circuits (ASICs) or other task-specific processors. The digital camera 10 may include an internal memory 64 to provide temporary storage during image processing operations, to act as a buffer during image capture operations, or to aid in any other operations that require internal storage space. The various components of the digital camera 10 (e.g., 62, 64, etc.) may be connected by a bus 76. The digital camera 10 may also include a user interface 70 to provide and process menus, process button input, communicate with external devices, etc. Note that the term user interface as used herein is not limited to processing menus or buttons or other communication directly with a user, but may perform other tasks in the digital camera 10 such as interfacing with connected devices, handling history attributes, etc.

Please note that the exemplary digital camera 10 is not limited to the elements described herein or to the configuration described herein. For example, the image processing system 66 and user interface 70 may be separate components in the digital camera 10, or may consist of firmware stored in one or more read-only memories (ROMS) that is executed by a processor 62. As the electronic imaging device is not limited to a digital camera 10, so the exemplary digital camera 10 is not limited to any particular configuration to provide the benefits of electronic image intent attributes.

Control buttons such as a shutter control button 16, a mode dial 20, a zoom control switch 22, and others (e.g., 24, 26 and 30) as needed are provided on the outside of the body 14.

The digital camera 10 may include an illumination system such as a flash 32 mounted on the outside of the body 14. Viewfinder windows 34 and 36 and display devices 40 and 42 are also located on the outside of the body 14. The foregoing systems and devices will now be described in more detail.

Image light enters the digital camera 10 through the lens assembly 12. The photodetector 60 detects the image light focused thereon by the lens assembly 12. In one exemplary embodiment the photodetector 60 comprises a charge-coupled device (CCD), although other types of photodetectors may be used. A typical CCD comprises an array of individual cells or pixels, each of which collects or builds up an electrical charge in response to exposure to light. Because the quantity of the accumulated electrical charge in any given cell or pixel is related to the intensity and duration of the light exposure, a CCD may be used to detect light and dark spots in an image focused thereon.

The term image light as used herein refers to the light, visible or otherwise, that is focused onto the surface of the photodetector by the lens assembly 12. The image light may be converted into digital signals in essentially three steps. First, each pixel in the photodetector converts the light it receives into an electric charge. Second, the charges from the pixels are amplified by an analog amplifier. Finally, the amplified analog charges are digitized by an analog-to-digital (A/D) converter, representing the voltage level of each amplified charge with a number. The digital data may then be processed and/or stored as desired.

The image data captured by the photodetector 60 may be buffered and processed in the internal memory 64 and stored in the solid-state storage device 72 in the digital camera 10. The solid-state storage device 72 may comprise any suitable type of memory, such as a removable rewriteable non-volatile memory, random access memory (RAM), or any other solid state storage medium. For example, the solid-state storage device 72 in the exemplary digital camera 10 may comprise a Compact Flash or SmartMedia memory card. (Note that history attributes are not limited to use with electronic imaging devices with solid-state memories, such as the exemplary digital camera 10 described herein.)

The image processing system 66 processes and formats the image data, either before or after storage in the solid-state storage device 72. As discussed above, the image processing system 66 may comprise any suitable device such as a microprocessor and computer-executable instructions in an associated memory, or a hard-coded device such as an ASIC. The image processing system 66 processes image data to scale images for display on a graphical display device 42, among other tasks. The graphical display device 42 comprises a liquid crystal display (LCD) or any other suitable display device. An alphanumeric display device 40 on the digital camera 10 also comprises an LCD or any other suitable display device, and is used to indicate status information, such as the number of images which can be captured and stored in the storage device 72, and the current mode of the digital camera 10.

The user interface 70 may also be implemented using any suitable device such as a microprocessor and computer-executable instructions in an associated memory, or a hard-coded device such as an ASIC. The user interface 70 may process input from the buttons (e.g., 16) on the digital camera 10, communicate with external devices, and provide menus and other aids to the user. In particular, the user interface 70 enables the user to select or enter tasks to perform with electronic images and may associate history attributes with images listing the tasks, as will be described in more detail below.

The digital camera 10 may also include other components, such as an audio system. However, digital cameras are well-known in the art and could be adapted to employ intent attributes by persons having ordinary skill in the art after having become familiar with the teachings of the present invention. Therefore, the components of the digital camera 10 utilized in one embodiment of the present invention, as well as the various ancillary systems and devices that may be utilized in one embodiment of the present invention, will not be described in further detail herein.

During operation of the digital camera 10, the digital camera 10 is turned on and off by one of the control buttons such as the mode dial 20, and a mode is selected, such as a single or multiple exposure mode. The digital camera 10 is oriented with the lens assembly 12 directed at a subject. The subject may be monitored either through a viewfinder 34 and 36, or on the graphical display panel 42. If the lens assembly 12 is a zoom lens, the focal length may be adjusted by pressing a control button such as the zoom control switch 22.

As the shutter control button 16 is pressed, the lens assembly 12 is adjusted to focus image light from the subject onto the photodetector 60. The flash 32 illuminates the subject, if needed. The photodetector 60 then converts the image light directed thereon by the lens assembly 12 into electrical image data, which are stored in the solid-state storage device 72. The user may perform various tasks with the electronic image in the digital camera 10 depending upon the capabilities of the digital camera 10, and history attributes are associated with the electronic image recording what is done with the image. For example, if the digital camera 10 is capable of transmitting images directly to a printer, the digital camera 10 may add a history attribute to the image or update an existing history attribute in the image indicating that the image has been printed. The history attribute may also indicate other information if desired, such as the date and time the action was performed and more detailed information about the task, such as the printer identification and printer settings.

The history attribute may be added before or after the action has been completed depending upon the environment in which the task is performed. For example, if the digital camera 10 receives confirmation from the printer that the image has been printed, the history attribute may be added after confirmation is received. If the digital camera 10 does not receive confirmation from the printer that the image has been printed, the history attribute may be added after the print command is entered but before the image is actually transmitted to the printer. The status of the action may also be added to the history attribute, indicating for example whether the action has been performed and whether it was successful.

Now that an exemplary digital camera 10 that may capture electronic images has been described, the history attribute associated with images will be described in more detail. The history attribute is associated with an image to indicate what tasks have been performed with the image, that is, what has been done with the image.

History attributes may be associated with electronic images in a variety of manners, either embedded in image files or separately with some type of link to the appropriate image files. For example, history attributes may be embedded in the image files as information tags, as described in the EXIF specification, the Digital Still Camera Image File Format Standard (Exchangeable image file format for Digital Still Cameras: Exif) Version 2.1, Jun. 12, 1998, Japan Electronic Industry Development Association, either in existing EXIF fields or additional fields. Alternatively, history attributes may be stored outside of the image files with links or pointers between image files and history attribute files, or a database may be configured to associate history attributes with image files, etc.

In the exemplary embodiment described herein, history attributes are transferred along with the electronic images. For example, if actions are performed with electronic images in the digital camera 10, history attributes are associated with the images. If the electronic images are then transferred from the digital camera 10 to other devices in copy or move operations, the history attributes are transferred with the images (and updated to reflect the copy or move operation). When the image file is transferred to a computer connected to the digital camera 10, the history attribute is transferred as well with the association left intact, either with the history attribute stored in the image file, or with the history attribute transferred separately along with the link tying the two together, so that the computer can display the history of actions performed with the image.

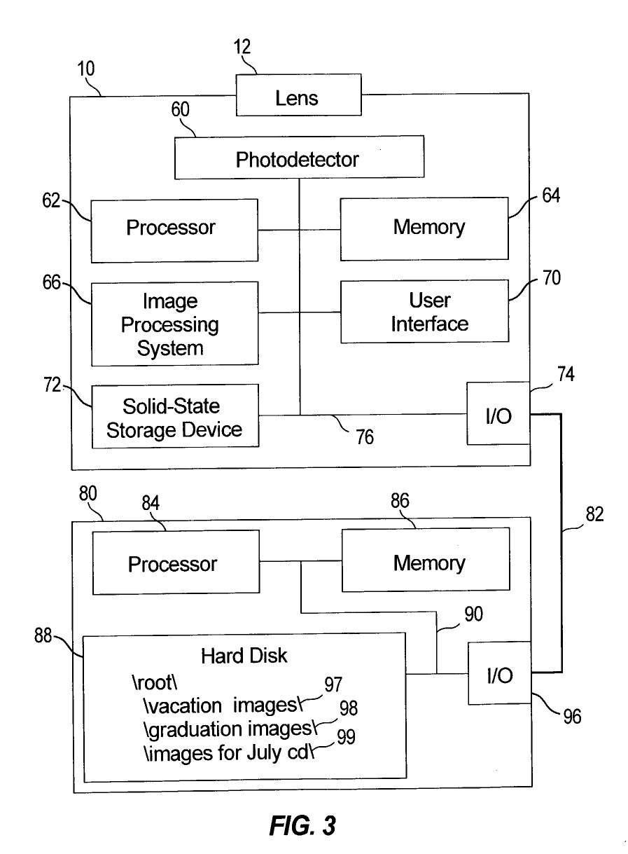

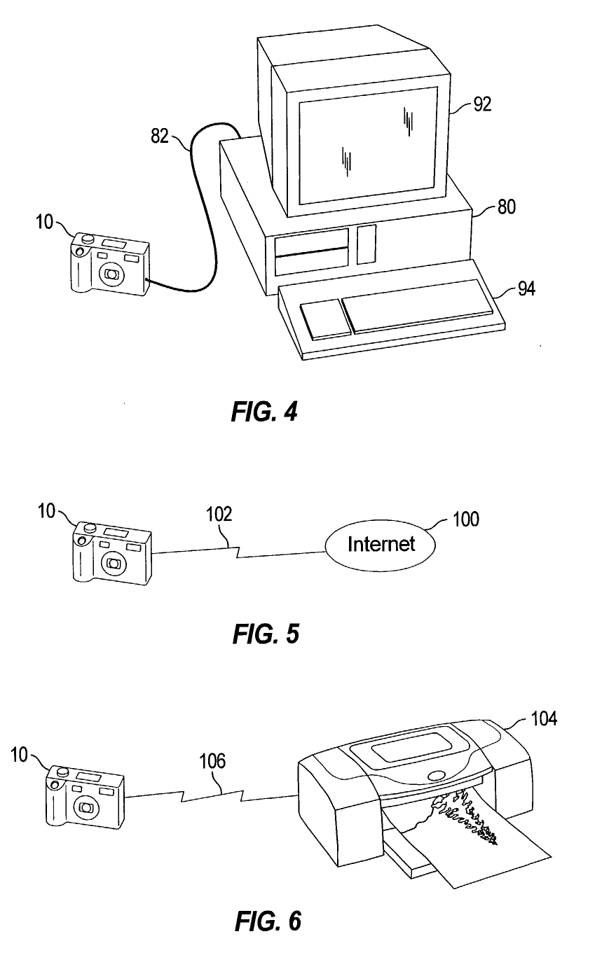

Referring now to FIGS. 3 and 4, the digital camera 10 may be connected to various external devices, such as a computer 80, to which images may be transferred. An exemplary computer 80 to which the digital camera 10 may be connected may comprise a processor 84, memory 86, hard disk 88, and other internal components linked by a bus 90. The computer 80 may also comprise a monitor 92, keyboard 94, and other components as is well known. The digital camera 10 may be connected to the computer 80 by a cable 82 attached to Input/Output (I/O) components 74 and 96 in the digital camera 10 and computer 80.

Various actions may be performed with an electronic image on the computer 80 connected to the digital camera 10, such as copying or moving the image from the digital camera 10 to a specific location in the computer 80, printing the image on a printer (not shown) connected to the computer 80, transmitting the image via a network (not shown) connected to the computer 80, etc.

History attributes may be used to record actions performed with the images in the digital camera 10, while the digital camera 10 is connected to the computer 80, and in the computer 80 after the digital camera 10 is disconnected, and at any other time by any device having access to the images. For example, if electronic images are copied to particular locations or directories in the computer 80, such as to a directory 97 for images of a vacation, or another directory 98 for images of a graduation, history attributes associated with the electronic images may be added or updated to record these actions. The history attribute may also indicate that the associated image files have been copied to a particular piece of media. For example, images may be marked with a history attribute indicating that they have been stored on a CD-ROM 99 of a given label or serial number.

The history attributes may be added by any suitable device. For example, if the actions are performed by the digital camera 10, the digital camera 10 may add the history attributes before the electronic images are transferred to the computer 80. If the actions are performed by the computer 80, the computer 80 may add the history attributes after the electronic images are transferred from the digital camera 10. Alternatively, history attributes may be added by the device in which actions are successfully completed, regardless of which device initiated the action. For example, an intent to perform an action may be entered in the digital camera 10, causing the action to be performed when the associated electronic image is transferred to the computer 80. In this embodiment, the computer 80 may add the action to the history attribute after the action is successfully performed by the computer 80. Alternatively, the digital camera 10 may add the action to the history attribute before the electronic image is transferred and the action is performed, along with a status indicator in the history attribute indicating that the action has not yet been performed. After the action is performed in the computer 80, the compute 80 may then update the status indicator in the history attribute to indicate successful performance of the action.

However, when actions result in multiple copies of an electronic image, such as when an image is copied from the digital camera 10 to the computer 80, it may be desirable to have a history attribute in both copies indicating this action. In this case, it may be most efficient to associate the history attribute with the electronic image before the copy action is performed so that the new history attribute is copied automatically along with the electronic image.

Other exemplary actions that may be performed with electronic images are illustrated in FIGS. 5 and 6. Referring now to FIG. 5, the digital camera 10 may be connected directly to a network such as the Internet 100 by a connection such as a wireless radio-frequency (RF) link 102. The digital camera 10 may be used to transmit electronic images to an archive on the World Wide Web, post images on a web page, or send images via email to various recipients. In these cases, the digital camera 10 indicates these actions with history attributes associated with the electronic images, generally after the action is commanded and before the actions are performed in these cases.

Referring now to FIG. 6, the digital camera 10 may also be connected to a printer 104 by a connection such as a wireless Infrared (IR) link 106. The digital camera 10 may associate a history attribute with an electronic image when it is printed, either before or after. As mentioned above, if the printer 104 sends confirmation of a successful print action, it may be desirable to wait for the confirmation before the digital camera 10 associates the history attribute with the electronic image indicating that it has been printed.

The history attributes may be transferred along with image files, either in the image files or separately along with a link or other type of association, so that devices other than the digital camera 10 may display actions performed with the electronic images even by previous devices such as the digital camera 10.

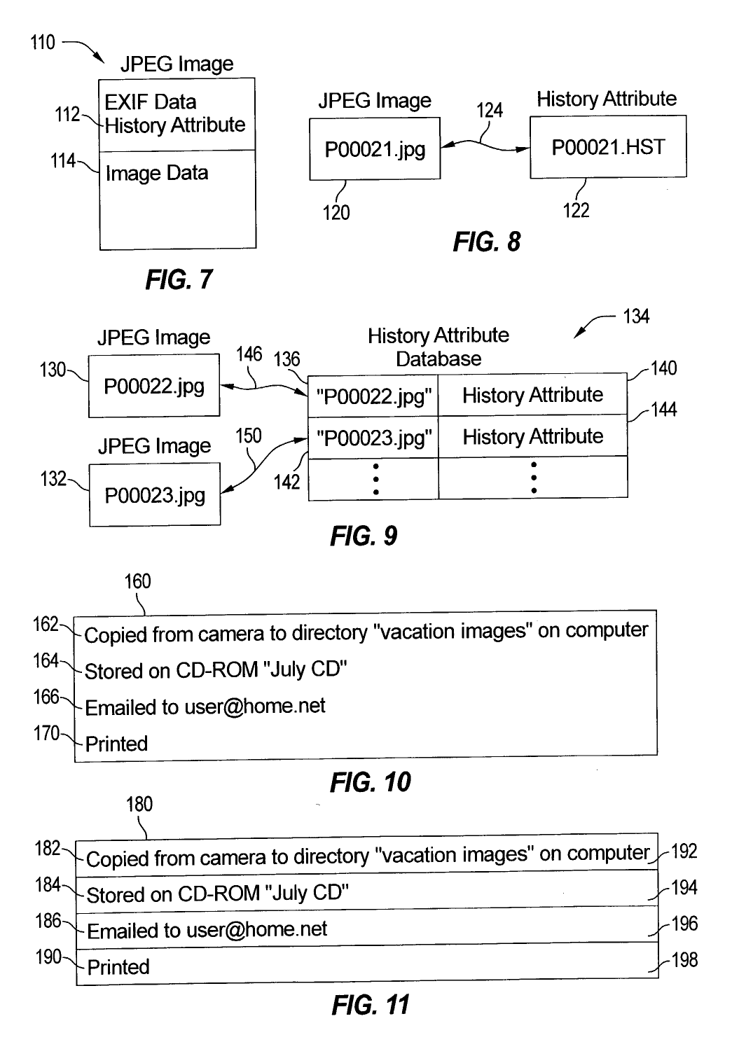

Exemplary means of associating history attributes with electronic images are illustrated in FIGS. 7-9. In one exemplary embodiment illustrated in FIG. 7, a history attribute 112 is associated with a JPEG (Joint Photographic Experts Group) format electronic image 110 by storing the history attribute 112 in the image file along with the image data 114. In this embodiment, the history attribute 112 may be stored as a field in the EXIF data, as mentioned above, or may be stored separately in any suitable format.

In another exemplary embodiment illustrated in FIG. 8, a history attribute 122 is associated with an image file 120 by some type of link or association 124. For example, the history attribute 122 may be stored in its own file and identified with its corresponding electronic image by using the same file name as the electronic image 120 but with a different file extension, such as “P00021.HST” for the history attribute 122 corresponding to the image file 120 “P00021.JPG”. The association may alternatively be established using a third file pointing to both the electronic image and the corresponding history attribute.

In another exemplary embodiment illustrated in FIG. 9, a database 134 is established containing history attributes (e.g., 140 and 144) corresponding to image files (e.g., 130 and 132) containing electronic images. An exemplary database configuration contains two fields in each record, one (e.g., 136 and 142) identifying the electronic image and the other (e.g., 140 and 144) containing the corresponding history attribute. The database thus contains the history attributes (e.g., 140 and 144) with a link 146 and 150 to the corresponding electronic images 130 and 132. Note that in the latter two embodiments in which history attributes are not embedded in the image files, extra work must be done when transferring image files in order to transfer the corresponding history attributes.

Again, the history attribute is associated with an image to indicate what actions have been performed with the image. The following are some examples of actions that may be performed with an electronic image and recorded in history attributes associated with the image:

copying from a digital camera to the directory “vacation images” on a computer

storing on a CD-ROM entitled “July CD”

emailing to user@home.net

printing

posting to World Wide Web server for display

ordering prints from a commercial image printing service or a printer on a network

ordering products bearing or otherwise containing the image, such as a candle with the image

archiving the image, e.g., at an Internet-based archival service

Note that history attributes are not limited to any particular action that may be performed with an electronic image, although the exemplary actions listed above deal with placing images in various locations, either copying them to directories in a connected computer, storing them on removable media, transmitting them via email to given addresses, or printing them. As much information as desired about the action may be stored in the history attribute, including date and time, source and destination of the electronic image during the action, extra identifying information about the destination, the identity of the user who commanded the action, etc. This list is not meant to be exhaustive, either in the specific actions listed or the details included in exemplary history attributes.

Various exemplary configurations for history attributes are illustrated in FIGS. 10-12. In one exemplary embodiment (FIG. 10), the history attribute 160 consists of a single text field containing a record of multiple actions 162, 164, 166 and 170. The text field is expandable so that as a new action is performed with the associated electronic image, a new line is added to the history attribute 160. This configuration is easily readable and displayable, as the history attribute can simply be opened into a text viewer, but searching for particular actions or action details is inefficient.

Another exemplary embodiment is illustrated in FIG. 11, wherein the history attribute 180 is divided into fields 192, 194, 196 and 198, each containing a single action 182, 184, 186 and 190, respectively, in text format. In this embodiment, a new field is added for each new action performed with the associated electronic image. To access and display the history attribute 180, a viewer may be programmed to display one field per line, wrapping the text as needed to fit in the display, as is well known.

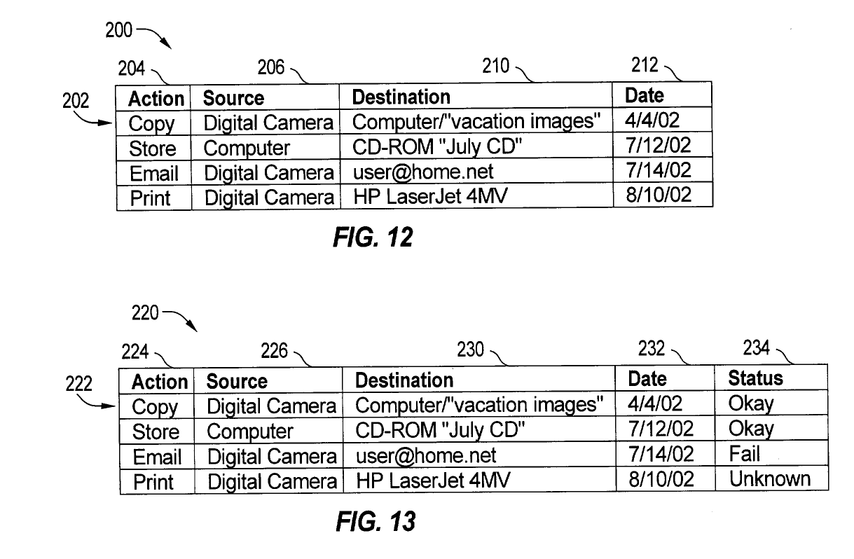

Another exemplary embodiment is illustrated in FIG. 12, wherein the history attribute 200 is further subdivided in typical database or spreadsheet format so that each action is recorded in a record (e.g., 202). Records (e.g., 202) are divided into fields, such as action 204, source 206, destination 210 and date 212 fields. This configuration may complicate access and display of the history attribute 200, although accessing information in this format for display is well known. Searching, however, may be much more efficient when action information is stored in this format.

Alternatively, history attributes may be encoded rather than storing them in text format, reducing the required storage space. For example, each potential action may be assigned a code, requiring only a few bits of storage space, with action details similarly encoded if desired. However, encoding the history attributes requires that software accessing the history attributes include special programming to interpret the codes, unlike the text format history attributes described above.

Another exemplary embodiment is illustrate in FIG. 13, wherein the history attribute 220 includes a status indicator 234 along with the action 224, source 226, destination 230 and date 232 fields in each record 222. In this embodiment, the history attribute may be associated with an electronic image as soon as an action is commanded. For example, an intent to print an image may be entered in a digital camera so that the image is printed when it is transferred to a computer. The history attribute associated with the electronic image may be updated to indicate the print action, along with a status such as “unknown” or “pending” to indicate that the action has not yet been performed. After the action is successfully performed, or after any other change of status for the action, the status field 234 of the history attribute 220 may be updated accordingly.

As mentioned above, electronic devices having access to electronic images and their associated history attributes may access and display the history attributes, enabling the user to quickly determine what has been done with the image. It may be desirable to allow the user to perform searches or queries on history attributes. For example, if history attributes are grouped so that they can be accessed in a single query operation, the user may pull up a list of all images emailed to a certain destination within a given date range, etc. Methods of accessing and displaying information in various electronic devices are well known and will not be described in detail herein, as they are typically tailored to the device capabilities. For example, displaying information in a digital camera 10 typically requires a simple and fast user interface to access the information, which is then arranged and sized to be displayed on a small display panel 42.

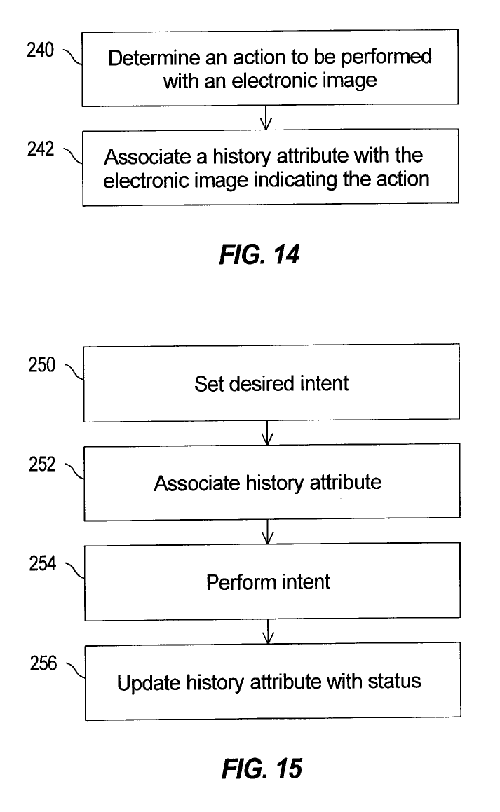

In summary, actions performed with an electronic image may be tracked by determining 240 (FIG. 14) the action to be performed with the image and associating 242 an indication of the action with the image as a history attribute. The history attribute may be associated with the electronic image in any suitable manner, such as embedding the history attribute in the same image file as the electronic image. The history attribute may be associated with the electronic image either before or after the action is performed, and may be transferred along with the electronic image between electronic devices. The history attributes may then be accessed and displayed to inform users what has been done with the electronic image.

Alternatively, as discussed above, if intents to perform future actions may be stored for electronic images, the history attribute may provide for status indicators. In this embodiment, the desired intent to perform a future action is set 250 (FIG. 15), and the history attribute is associated 252 with the electronic image, indicating the action to be performed. The intended action is performed 254, and the history attribute is updated 256 with the status of the action.

While illustrative embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of tracking actions performed with an electronic image, comprising:
determining an action to be performed with said electronic image;
associating an indication of said action with said electronic image as an action history.

2. The method of claim 1, wherein said associating said indication of said action comprises storing a history attribute in an image file containing said electronic image.

3. The method of claim 1, wherein said associating said indication of said action comprises storing a history attribute in an attribute file associated with one or more electronic images including said electronic image.

4. The method of claim 1, wherein said associating said indication of said action comprises associating at least one string describing said action with said electronic image.

5. The method of claim 1, wherein said associating said indication of said action comprises associating at least one encoded description of said action with said electronic image.

6. The method of claim 1, wherein said action to be performed with said electronic image comprises copying said electronic image, said indication identifying a destination of a copy of said electronic image.

7. The method of claim 1, wherein said action to be performed with said electronic image comprises transmitting said electronic image by electronic mail to a destination, said indication identifying said destination.

8. The method of claim 1, wherein said action to be performed with said electronic image comprises printing said electronic image, said indication indicating that said electronic image has been printed.

9. The method of claim 1, wherein said action to be performed with said electronic image comprises transmitting said electronic image to a server on the Internet.

10. The method of claim 1, wherein said action to be performed with said electronic image comprises displaying said electronic image on the World Wide Web.

11. The method of claim 1, wherein said action to be performed with said electronic image comprises ordering a print of said electronic image.

12. The method of claim 1, wherein said action to be performed with said electronic image comprises ordering a product containing said electronic image.

13. The method of claim 1, wherein said action to be performed with said electronic image comprises archiving said electronic image.

14. The method of claim 1, further comprising performing said action with said electronic image.

15. The method of claim 14, wherein said indication of said action is associated with said electronic image before said action is performed.

16. The method of claim 14, wherein said indication of said action is associated with said electronic image after said action is performed.

17. The method of claim 1, wherein said action to be performed is determined in an electronic imaging device, the method further comprising:
transferring said electronic image to a computer from said electronic imaging device;
transferring a command to perform said action to said computer from said electronic imaging device; and
performing said action in said computer with said electronic image.

18. The method of claim 17, wherein said indication of said action is associated with said electronic image in said computer.

19. The method of claim 17, wherein said indication of said action is associated with said electronic image in said electronic imaging device.

20. The method of claim 1, further comprising retrieving a list of at least one action previously associated with said electronic image and displaying said list.

21. The method of claim 1, further comprising associating an indication of a status of said action with said electronic image.

22. Apparatus for tracking actions performed with an electronic image, the apparatus comprising:
a. one or more computer readable storage media; and
b. computer readable data stored in the one or more computer readable storage media, the computer readable data comprising:
i. data representing an electronic image; and
ii. data representing a history of actions performed with said electronic image, wherein said data representing said history of actions is associated with said data representing said electronic image.

23. The apparatus of claim 22, wherein said data representing said history of actions and said data representing said electronic image are stored in a single file.

24. The apparatus of claim 22, wherein said data representing said history of actions and said data representing said electronic image are stored in multiple files, said computer readable data further comprising data specifying said association between said data representing said history of actions and said data representing said electronic image.

25. An apparatus for processing electronic images, comprising:
means for determining an action to be performed with an electronic image; and
means for associating a history attribute with said electronic image, said history attribute comprising an indication of said action.
